(19) United States
(12) Patent Application Publication
(10) Pub. No.: US 2006/0126807 A1
(43) Pub. Date: Jun. 15, 2006

(54) Music on hold device

(76) Inventor: Robert P. Weil, Thompsons Station, TN (US)

Correspondence Address: Robert P.Weil, 2804 Stacey Street, Thompsons Station, TN, 37179, US

(21) Appl. No.: 11/012,919

(22) Filed: Dec. 15, 2004

(51) Int. Cl. H04M 11/00; H04M 1/00; H04M 3/00

(52) U.S. Cl. 379/101.01; 379/374.01

(57) ABSTRACT

The invention described herein is an external telephone accessory for the purpose of placing a call in an on-hold state while simultaneously providing the caller on hold with music from a CD player, mp3 player, computer sound card, or other external audio source. The basic form of the invention consists of a housing having a pushbutton switch to mechanically switch the telephone signal and activate an LED to indicate the on-hold state, input and output modular telephone jacks, and an input jack for the audio source.

### BACKGROUND

1. Field of Invention

This invention relates to telephone accessories, specifically to a simplified and improved design for providing music on hold to callers.

2. Discussion of Prior Art

Music on hold devices have been in existence for many years. Some have been external devices, while more commonly music on hold has simply been a feature available in larger telephone PBX systems. The latter will not be a part of this discussion as it does not relate to external accessory devices such as this invention.

Previous inventions for external music on hold all concentrated on remote switching by pushing one or more buttons on a telephone keypad to enable or disable an on-hold state. While this method has its advantages, especially with cordless phones, it gives callers an unpleasant beep sound for each key pushed on the telephone while activating the on-hold state. It is also unnecessary in most applications for people to have remote switching capability since they are normally working at a desk when the need arises to place a caller on hold. This remote switching requires the music on hold device to be complex in its circuitry and thus, the cost of manufacturing is high.

Surprisingly, no music on hold devices currently or previously on the market have utilized simple mechanical switching in a passive circuit. This method is by far the least expensive to manufacture and is also the most reliable.

### OBJECTS AND ADVANTAGES

The objects and advantages of my invention are as follows:

(a) The invention provides a simple, low-cost method to provide music on hold to callers who use standard corded or cordless telephones. This is achieved by using mechanical switching in a passive circuit;

(b) The caller is kept on hold by simply keeping a 220 Ohm load resistor across the positive and negative telephone signal wires to provide current load on the telephone line. Without this resistor, the call would be disconnected when switched to the music on hold condition.

(c) An LED, powered by voltage from the telephone line, indicates the on-hold state and is immune from polarity mismatches commonly found in telephone wiring;

(d) This polarity protection for the LED is provided by a series of diodes arranged in a bridge rectifier configuration which corrects any polarity mismatch in the telephone wires, thus allowing the LED to light properly whether the telephone wiring was installed properly or not;

(e) An audio isolation transformer in the circuit allows the invention to be connected not only to a CD player or mp3 player, but also to a computer sound card or any other sound source, by separating audio ground from telephone ground and thus eliminating noise and interference caused by grounding conflicts between AC powered devices and telephone line DC powered devices like this invention.

Further objects and advantages of my invention will become apparent from a consideration of the drawings and ensuing description.

### DRAWING FIGURES

FIG. 1 is a perspective view of my invention.

FIG. 2 is a simplified schematic of the circuit showing external connections and signal path.

### NUMERALS IN DRAWINGS

1 The invention as a whole

2 Housing

3 Pushbutton Switch

4 LED

5 Telephone Line Input Jack

6 Telephone Output Jack

7 Audio Input Jack

8 220 Ohm Load Resistor

9 Audio Isolation Transformer

10 Diode Array

### DESCRIPTION OF INVENTION

The following detailed description illustrates the invention by way of example and not by way of limitation of the principles of the invention. The example shown may or may not be the best embodiment of the invention, but is merely the first embodiment to be made and tested. Anyone skilled in the art will be able to assemble their own particular design, based on the invention, using materials and circuitry which are already in use today.

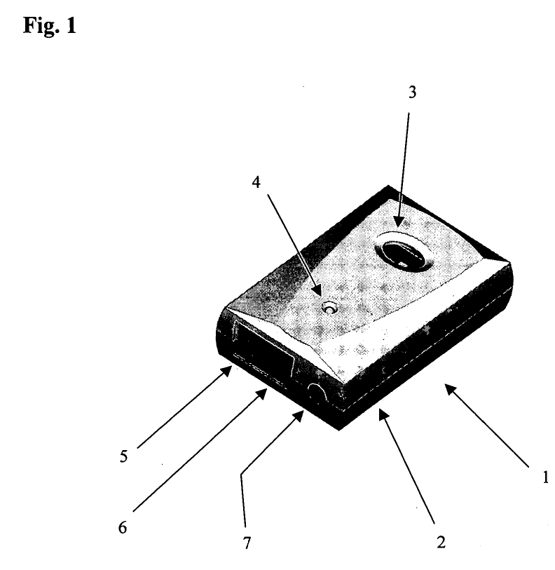

FIG. 1 shows a perspective view of the current embodiment of the invention 1. A housing 2, normally constructed with a top piece and bottom piece, has a pushbutton switch 3 protruding through the top. An LED 4 protrudes through the top of the housing 2 and indicates the on-hold condition when lit. A modular telephone cable coming from a wall jack plugs into the telephone line input jack 5. Another modular telephone cable coming from a corded or cordless telephone base plugs into the telephone output jack 6. A stereo 3.5 mm (⅛″) input cable plugs into the audio input jack 7.

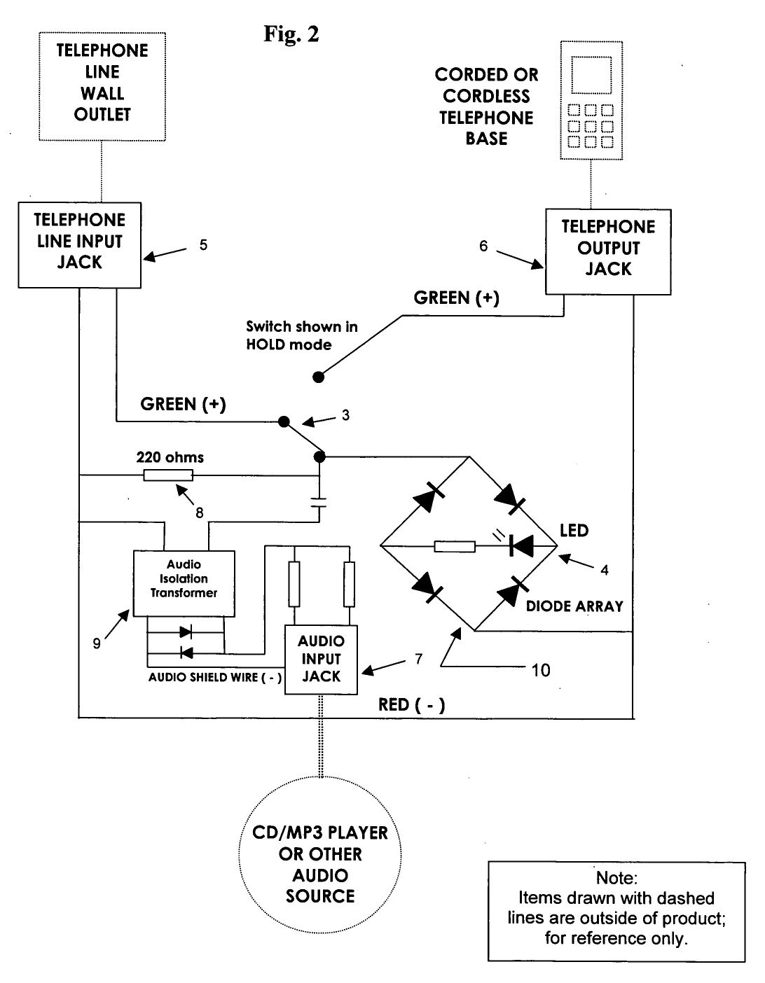

FIG. 2 is a simplified schematic of the circuit showing external connections and signal path. A telephone wall jack is connected to the telephone line input jack 5 by means of a modular telephone cable. When not activated, the telephone line signal simply passes through the pushbutton switch 3 to the telephone output jack 6 and to the telephone unaffected, via a modular telephone cable connected to the telephone output jack 6. When the pushbutton switch 3 is pushed down, the telephone signal from the telephone line input jack 5 is routed to the audio input jack 7 so that the caller will hear music and/or messages while on hold. The call is kept from being disconnected by a 220 Ohm load resistor 8.

In addition to routing the call to the audio input jack 7, the pushbutton switch 3 also connects the voltage available on the telephone line to the LED 4, causing it to light and indicate the on-hold state. The diode array 10 acts as a bridge rectifier to correct any polarity mismatch between the telephone wiring and the LED 4. An audio isolation transformer 9 in the circuit allows the invention to be connected not only to a CD player or mp3 player, but also to a computer sound card or any other sound source, by separating audio ground from telephone ground and thus eliminating noise and interference caused by grounding conflicts between AC powered devices and telephone line DC powered devices like this invention.

### CONCLUSION, RAMIFICATIONS, AND SCOPE

At this point, it should be noted that the specific design of the component parts described in FIGS. 1 and 2 are not of particular importance since music on hold devices can be manufactured in various forms. The uniqueness of this invention is the combination of low-cost mechanical switching of a telephone signal to an on-hold state while simultaneously switching an audio circuit to the caller on hold and providing a polarity protected LED to indicate the on-hold state. The mechanical switch can take many forms and is not limited to the pushbutton type; it could just as easily be a rocker, toggle, slide, or other mechanical switch. The diode array used in the LED polarity protection part of the circuit could be a bridge rectifier chip rather than a series of four diodes as is used in the current embodiment of the invention. The 220 Ohm resistor which keeps the on-hold caller from being disconnected can be any resistor of a similar value.

The scope of this invention may include, but should not be limited to, the following types of music on hold telephone devices: single line or multi-line external music on hold device, external music on hold device with an integrated mp3 player, a non-PBX system telephone (such as a standard home telephone) which includes integrated switching for music on-hold from an internal or external audio source. In any of these embodiments, the telephone, audio, and LED indicator signals can be switched mechanically, thus providing a simple, reliable, and low-cost method of placing callers on hold while simultaneously providing them with music and/or messages.

Thus the scope of the invention should be determined by the appended claims and their legal equivalents, rather than by the examples given.

I claim:

1. A music on hold device comprising:
a housing;
an alternate action pushbutton switch projecting through said housing for the purpose of mechanically switching a telephone circuit to an on-hold state while simultaneously switching an audio circuit to the caller;
an LED to indicate said on-hold state, turned on or off by said switch;
a bridge rectifier or series of diodes in combination with said LED to correct potential polarity mismatch between the telephone line voltage and said LED;
a resistor connecting the positive and negative telephone signal wires provides current load on the telephone line during said on-hold state to keep a call from being disconnected;
an audio isolation transformer to separate audio source ground from telephone line ground.
